(19) United States
(12) Patent Application Publication
(10) Pub. No.: US 2015/0085144 A1
(43) Pub. Date: Mar. 26, 2015

(54) DUAL VIDEO GRAPHICS ARRAY CONNECTORS TESTING SYSTEM

(71) Applicants: HON HAI PRECISION INDUSTRY CO., LTD., New Taipei (TW); HONG FU JIN PRECISION INDUSTRY (SheZhen) CO., LTD., Shenzhen (CN)

(72) Inventor: SHENG-YI LI, Shenzhen (CN)

(73) Assignees: HON HAI PRECISION INDUSTRY CO., LTD., New Taipei (TW); HONG FU JIN PRECISION INDUSTRY (SheZhen) CO., LTD., Shenzhen (CN)

(21) Appl. No.: 14/140,554

(22) Filed: Dec. 26, 2013

(30) Foreign Application Priority Data
Sep. 23, 2013 (CN) 2013104349106

(51) Int. Cl. H04N 17/00

(52) U.S. Cl. CPC H04N 17/004
USPC 348/192

(57) ABSTRACT

A dual VGA connectors testing system includes an exchanging module and a controlling module connected to the exchanging module. The exchanging module includes a number inputting terminals and a number of outputting terminals. First group of RGB signal inputting terminals are connected to RGB signal outputting terminals, first group of scanning and controlling signal inputting terminals are connected to scanning and controlling signal outputting terminals, and first group of address signal inputting terminals are connected to address signal outputting terminals when the controlling module outputs a first signal; second group of RGB signal inputting terminals are connected to the RGB signal outputting terminals, second group of scanning and controlling signal inputting terminals are connected to the scanning and controlling signal outputting terminals, and second group of address signal inputting terminals are connected to the address signal outputting terminals when the controlling module outputs a second signal.

### BACKGROUND

1. Technical Field

The present disclosure relates to testing systems, and particularly to a dual Video Graphics Array (VGA) connectors testing system.

2. Description of Related Art

More and more electronic devices have two VGA connectors connecting to other video devices, such as televisions. In quality tests, in order to improve testing efficiency, two displays are required to connect the two VGA connectors respectively at same time, which increases the testing cost.

Therefore, it is desirable to provide a dual VGA connectors testing system that can overcome the limitations described.

### BRIEF DESCRIPTION OF THE DRAWINGS

FIG. 1 is a functional block diagram of a dual VGA connectors testing system in accordance with an exemplary embodiment.

FIGS. 2-4 are a circuit diagram of the dual VGA connectors testing system of FIG. 1.

### DETAILED DESCRIPTION

Embodiments of the disclosure will be described with reference to the drawings.

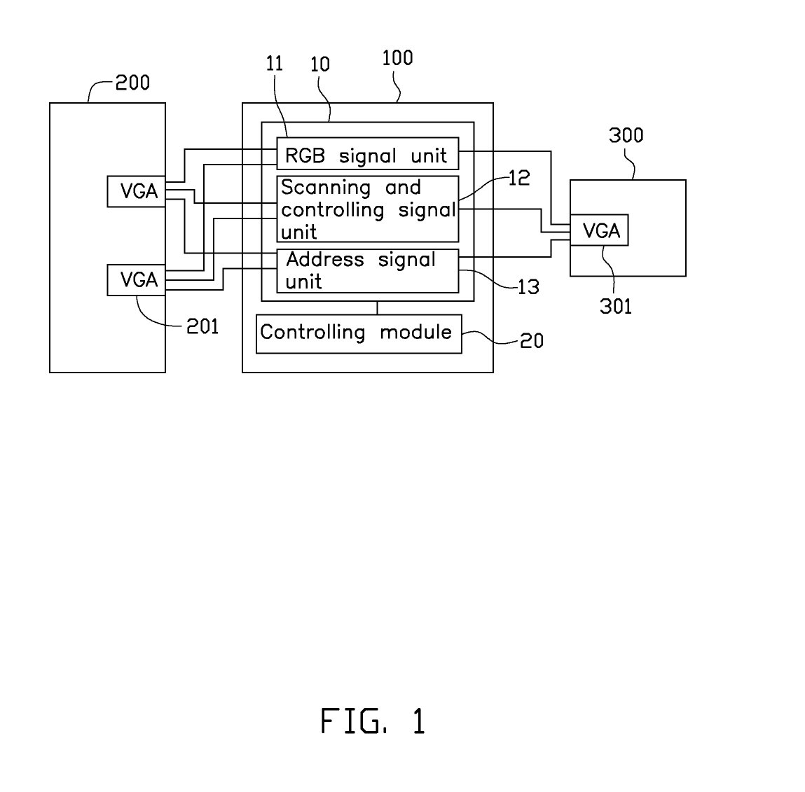

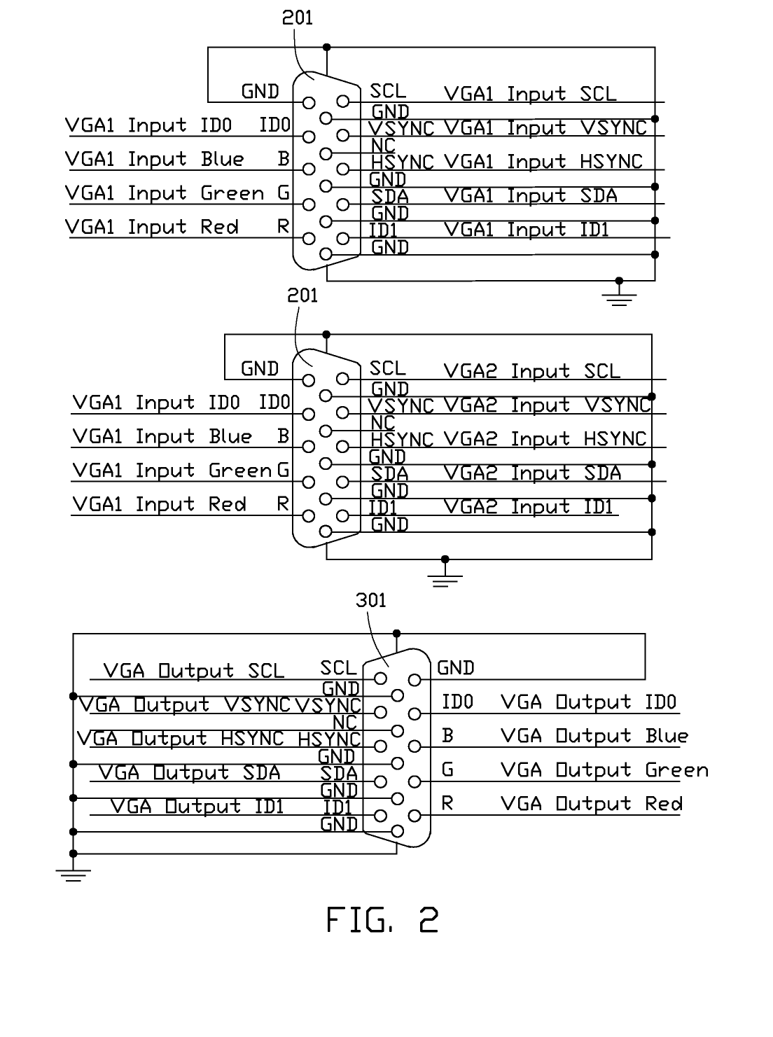

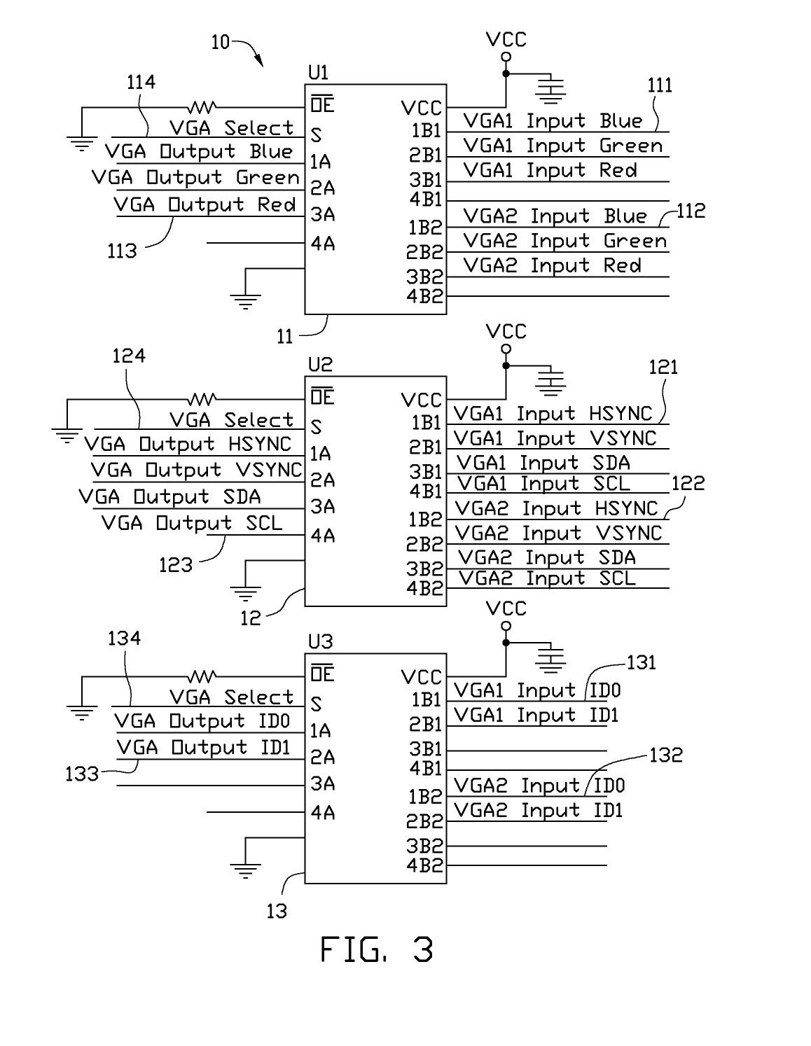

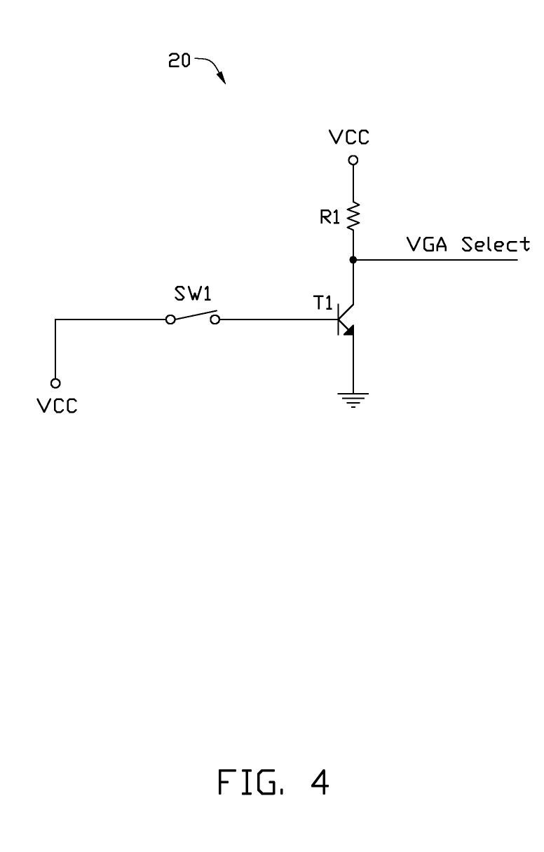

FIGS. 1-4 show a dual VGA connectors testing system 100, according to an exemplary embodiment. The dual VGA connectors testing system 100 is connected between two first VGA female connectors 201 mounted on a main board 200 and a second VGA female connector 301 of a video device 300. The VGA connector is a three-row 15-pin D-sub connector, each row has five pins. The VGA connector has three RGB color signal terminals, two scan synchronizing signal terminals, two address signal terminals, two bus signal terminals, and five GND signal terminals.

The dual VGA connectors testing system 100 includes an exchanging module 10 and a controlling module 20 connected to the exchanging module 10.

The exchanging module 10 includes a RGB signal unit 11, a scanning and controlling signal unit 12, and an address signal unit 13.

The RGB signal unit 11 includes a first group of RGB signal inputting terminals 111, a second group of RGB signal inputting terminals 112, a group of RGB signal outputting terminals 113, and a first controlling terminal 114. The RGB signal unit 11 is an exchanging chip U1. The first group of RGB signal inputting terminals 111 are three pins 1B1, 2B1, and 3B1 of the exchanging chip U1. The second group of RGB signal inputting terminals 112 are three pins 1B2, 2B2, and 3B2 of the exchanging chip U1. The RGB signal outputting terminals 113 are three pins 1A, 2A, and 3A of the exchanging chip U1. The first controlling terminal 114 is a pin S of the exchanging chip U1. The pins 1A, 2A, and 3A are connected with the pins 1B1, 2B1, and 3B1 respectively and disconnected with the pins 1B2, 2B2, and 3B2 respectively when the pin S is input a first signal, such as +5 V (volt). The pins 1A, 2A, and 3A are connected with the pins 1B2, 2B2, and 3B2 respectively and disconnected with the pins 1B1, 2B1, and 3B1 respectively when the pin S is input a second signal, such as 0 V (volt).

The scanning and controlling signal unit 12 includes a first group of scanning and controlling signal inputting terminals 121, a second group of scanning and controlling signal inputting terminals 122, a group of scanning and controlling signal outputting terminals 123, and a second controlling terminal 124. The scanning and controlling signal unit 12 is an exchanging chip U2. The first group of scanning and controlling signal inputting terminals 121 are pins 1B1, 2B1, 3B1, and 4B1 of the exchanging chip U2. The second group of scanning and controlling signal inputting terminals 122 are pins 1B2, 2B2, 3B2, and 4B2 of the exchanging chip U2. The scanning and controlling signal outputting terminals 123 are pins 1A, 2A, 3A, and 4A of the exchanging chip U2. The second controlling terminal 124 is a pin S of the exchanging chip U2. The pins 1A, 2A, 3A, and 4A are connected with the pins 1B1, 2B1, 3B1, and 4B1 respectively and disconnected with the pins 1B2, 2B2, 3B2, and 4B2 respectively when the pin S is input a first signal, such as +5 V (volt). The pins 1A, 2A, 3A, and 4A are connected with the pins 1B2, 2B2, 3B2, and 4B2 respectively and disconnected with the pins 1B1, 2B1, 3B1, and 4B1 respectively when the pin S is input a second signal, such as 0 V (volt).

In the embodiment, the pins 1A, 2A, 1B1, 2B1, 1B2, and 2B2 of the exchanging chip U2 are used for transmitting scanning signals, the pins 3A, 4A, 3B1, 4B1, 3B2, and 4B2 are used for transmitting controlling signals.

The address signal unit 13 includes a first group of address signal inputting terminals 131, a second group of address signal inputting terminals 132, a group of address signal outputting terminals 133, and a third controlling terminal 134. The address signal unit 13 is an exchanging chip U3. The first group of address signal inputting terminals 131 are pins 1B1 and 2B1 of the exchanging chip U3. The second group of address signal inputting terminals 132 are pins 1B2 and 2B2 of the exchanging chip U3. The address signal outputting terminals 133 are pins 1A and 2A of the exchanging chip U3. The third controlling terminal 134 is a pin S of the exchanging chip U3. The pins 1A and 2A are connected with the pins 1B1 and 2B1 respectively and disconnected with the pins 1B2 and 2B2 respectively when the pin S is input a first signal, such as +5 V (volt). The pins 1A and 2A are connected with the pins 1B2 and 2B2 respectively and disconnected with the pins 1B1 and 2B1 respectively when the pin S is input a second signal, such as 0 V (volt).

In the embodiment, types of the exchanging chips U1, U2, and U3 are same, and the exchanging chips U1, U2, and U3 are arrayed on a circuit board (not shown).

The first group of RGB signal inputting terminals 111, the first group of scanning and controlling signal inputting terminals 121, and the first group of address signal inputting terminals 131 are connected to a first VGA male connector (not shown) coupled to the first VGA female connectors 201. The second group of RGB signal inputting terminals 112, the second group of scanning and controlling signal inputting terminals 122, and the second group of address signal inputting terminals 132 are connected to a second VGA male connector (not shown) coupled to the other first VGA female connectors 201. The RGB signal outputting terminals 113, the scanning and controlling signal outputting terminals 123, and the address signal outputting terminals 133 are connected to a third VGA male connector (not shown) coupled to the second VGA female connector 301.

In the embodiment, the pins 1B1, 2B1, and 3B1 of the exchanging chip U1, the pins 1B1, 2B1, 3B1, and 4B1 of the exchanging chip U2, and the pins 1B1 and 2B1 of the exchanging chip U3 are connected to the first VGA male connector. The pins 1B2, 2B2, and 3B2 of the exchanging chip U1, the pins 1B2, 2B2, 3B2, and 4B2 of the exchanging chip U2, and the pins 1B2 and 2B2 of the exchanging chip U3 are connected to the second VGA male connector. The pins 1A, 2A, and 3A of the exchanging chip U1, the pins 1A, 2A, 3A, and 4A of the exchanging chip U2, and the pins 1A and 2A of the exchanging chip U3 are connected to the third VGA male connector.

The controlling module 20 is connected to the first controlling terminal 114, the second controlling terminal 124, and the third controlling terminal 134. The controlling module 20 outputs the first signal or the second signal to the first controlling terminal 114, the second controlling terminal 124, and the third controlling terminal 134.

In the embodiment, the controlling module 20 includes a transistor T1, a switch SW1, a resistor R1. The transistor T1 includes a collator C1, an emitter E1, and a base B1 configured for controlling connection or disconnection between the collator C1 and the emitter E1. The collator C1 is connected to a power source Vcc via the resistor R1. The base B1 is connected to another power source Vcc via the switch SW1. The emitter E1 is grounded. The collator C1 is directly connected to the first controlling terminal 114, the second controlling terminal 124, and the third controlling terminal 134.

Before testing, the first VGA male connector, the second VGA male connector, and the third VGA male connector are connected to the two first VGA female connectors 201 and the second VGA female connector 301 respectively. The three RGB color signal terminals of two first VGA female connectors 201 are connected to the first group of RGB signal inputting terminals 111 and the second group of RGB signal inputting terminals 112 respectively. The two scan synchronizing signal terminals and the two bus signal terminals of two first VGA female connectors 201 are connected to the first group of scanning and controlling signal inputting terminals 121 and the second group of scanning and controlling signal inputting terminals 122. The two address signal terminals of two first VGA female connectors 201 are connected to the first group of address signal inputting terminals 131 and the second group of address signal inputting terminals 132. The RGB signal outputting terminals 113, the scanning and controlling signal outputting terminals 123, and the address signal outputting terminals 133 are connected to the second VGA female connector 301.

During test, the controlling module 20 outputs the first signal to the first controlling terminal 114, the second controlling terminal 124, and the third controlling terminal 134. The first VGA female connector 201 connected to the first group of RGB signal inputting terminals 111, the first group of scanning and controlling signal inputting terminals 121, and the first group of address signal inputting terminals 131 is connected to the second VGA female connector 301. Therefore, this first VGA female connector 201 is testing. The controlling module 20 outputs the second signal to the first controlling terminal 114, the second controlling terminal 124, and the third controlling terminal 134. The first VGA female connector 201 connected to the second group of RGB signal inputting terminals 112, the second group of scanning and controlling signal inputting terminals 122, and the second group of address signal inputting terminals 132 is connected to the second VGA female connector 301. Therefore, another first VGA female connector 201 is tested.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A dual VGA connectors testing system, comprising:
an exchanging module, comprising:
a RGB signal unit comprising a first group of RGB signal inputting terminals, a second group of RGB signal inputting terminals, and a group of RGB signal outputting terminals;
a scanning and controlling signal unit comprising a first group of scanning and controlling signal inputting terminals, a second group of scanning and controlling signal inputting terminals, and a group of scanning and controlling signal outputting terminals;
an address signal unit comprising a first group of address signal inputting terminals, a second group of address signal inputting terminals, and a group of address signal outputting terminals;
a controlling module connected to the RGB signal unit, the scanning and controlling signal unit, and the address signal unit;
wherein the first group of RGB signal inputting terminals are connected to the RGB signal outputting terminals, the first group of scanning and controlling signal inputting terminals are connected to the scanning and controlling signal outputting terminals, and the first group of address signal inputting terminals are connected to the address signal outputting terminals when the controlling module outputs a first signal; the second group of RGB signal inputting terminals are connected to the RGB signal outputting terminals, the second group of scanning and controlling signal inputting terminals are connected to the scanning and controlling signal outputting terminals, and the second group of address signal inputting terminals are connected to the address signal outputting terminals when the controlling module outputs a second signal.

2. The dual VGA connectors testing system of claim 1, wherein the RGB signal unit is an exchanging chip, the first group of RGB signal inputting terminals are three pins of this exchanging chip, the second group of RGB signal inputting terminals are three pins of this exchanging chip, and the RGB signal outputting terminals are three pins of this exchanging chip.

3. The dual VGA connectors testing system of claim 1, wherein the scanning and controlling signal unit is an exchanging chip, the first group of scanning and controlling signal inputting terminals are four pins of this exchanging chip, the second group of scanning and controlling signal inputting terminals are four pins of this exchanging chip, and the scanning and controlling signal outputting terminals are four pins of this exchanging chip.

4. The dual VGA connectors testing system of claim 1, wherein the address signal unit is an exchanging chip, the first group of address signal inputting terminals are two pins of this exchanging chip, the second group of address signal inputting terminals are two pins of this exchanging chip, and the address signal outputting terminals are two pins of this exchanging chip.

5. The dual VGA connectors testing system of claim 1, wherein the RGB signal unit comprises a first controlling terminal, the scanning and controlling signal unit comprises a second controlling terminal, and the address signal unit comprises a third controlling terminal; the first controlling terminal, the second controlling terminal, and the third controlling terminal are connected to the controlling module.

6. The dual VGA connectors testing system of claim 1, wherein the controlling module comprises a transistor, a switch, a resistor; the transistor comprises a collator, an emitter, and a base configured for controlling connection or disconnection between the collator and the emitter; the collator is connected to a power source via the resistor, the base is connected to another power source via the switch, the emitter is grounded; the collator is directly connected to the first controlling terminal, the second controlling terminal, and the third controlling terminal.

7. A dual VGA connectors testing system, comprising:
an exchanging module, comprising:
a RGB signal unit comprising a first group of RGB signal inputting terminals, a second group of RGB signal inputting terminals, and a group of RGB signal outputting terminals;
a scanning and controlling signal unit comprising a first group of scanning and controlling signal inputting terminals, a second group of scanning and controlling signal inputting terminals, and a group of scanning and controlling signal outputting terminals;
an address signal unit comprising a first group of address signal inputting terminals, a second group of address signal inputting terminals, and a group of address signal outputting terminals;
a controlling module connected to the RGB signal unit, the scanning and controlling signal unit, and the address signal unit;
wherein the first group of RGB signal inputting terminals, the first group of scanning and controlling signal inputting terminals, and the first group of address signal inputting terminals are connected to a first VGA female connector; the second group of RGB signal inputting terminals, the second group of scanning and controlling signal inputting terminals, and the second group of address signal inputting terminals are connected to another first VGA female connector; the RGB signal outputting terminals, the scanning and controlling signal outputting terminals, and the address signal outputting terminals are connected to a second VGA female connector;
wherein the first group of RGB signal inputting terminals are connected to the RGB signal outputting terminals, the first group of scanning and controlling signal inputting terminals are connected to the scanning and controlling signal outputting terminals, and the first group of address signal inputting terminals are connected to the address signal outputting terminals when the controlling module outputs a first signal; the second group of RGB signal inputting terminals are connected to the RGB signal outputting terminals, the second group of scanning and controlling signal inputting terminals are connected to the scanning and controlling signal outputting terminals, and the second group of address signal inputting terminals are connected to the address signal outputting terminals when the controlling module outputs a second signal.
